(19) United States
(12) Patent Application Publication
(10) Pub. No.: US 2014/0307905 A1
(43) Pub. Date: Oct. 16, 2014

(54) Hearing Aid

(71) Applicant: Ron Jerome Leavitt, Independence, OR (US)

(72) Inventor: Ron Jerome Leavitt, Independence, OR (US)

(21) Appl. No.: 13/862,712

(22) Filed: Apr. 15, 2013

(51) Int. Cl. H04R 25/00

(52) U.S. Cl. CPC H04R 25/652
USPC 381/328

(57) ABSTRACT

A novel earpiece for a hearing aid having a speaker located at the medial end, adjacent a wearer's eardrum.

### BACKGROUND

A majority of hearing aids sold in the United States feature a speaker located in the wearer's ear. This design is superior to older designs, which placed speakers outside the ear and conducted sound into the ear through a hollow tube. However, current designs place the speaker near the opening of the ear canal, and conduct sound to the eardrum through a tube that, while shorter than earlier designs, is still relatively narrow. This has two negative effects on function and one negative effect on longevity. First, the impedance of the narrow tube varies as a function of frequency, and in particular is greater for high frequencies. This means that high frequencies are less available at the eardrum. Because consonant discrimination occurs mostly at high frequencies, this sacrifices speech clarity and comprehension. Second, due to the location of the speaker near the outside of the ear, more sonic power is naturally lost to the outside rather than being available to the wearer to assist in hearing. Finally, because wearers tend to grasp the wire connected to the speaker to remove their hearing aid, over time the speaker may become dislodged and move even farther away from the eardrum, increasing the likelihood of feedback and further reducing the energy available at the eardrum.

### SUMMARY

A hearing aid earpiece with a speaker located closer to the medial end of the earpiece than the lateral end.

### BRIEF DESCRIPTION OF THE DRAWINGS

FIG. 1 is a cross-section of a prior art hearing aid earpiece.

FIG. 2 is a perspective view of one embodiment of a novel hearing aid showing both the earpiece and a behind-the-ear unit.

FIG. 3 is a perspective view of an alternative embodiment of a novel earpiece.

FIG. 4 is a cross-section of one embodiment of a novel earpiece.

### DETAILED DESCRIPTION

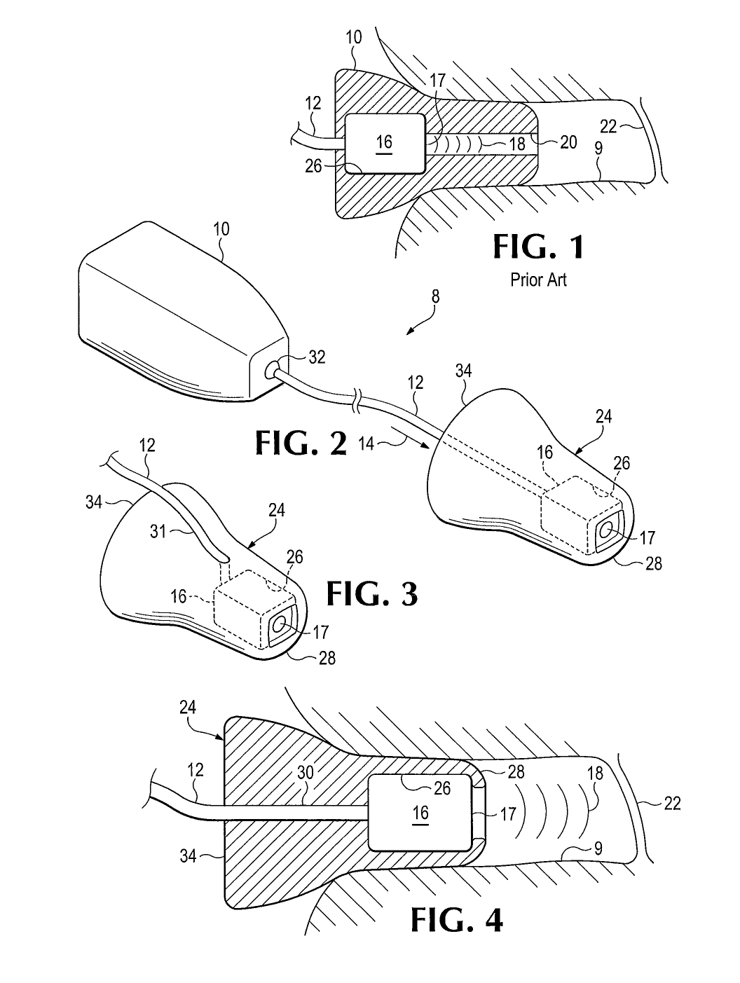

FIG. 1 shows a cross-section of a prior-art earpiece 8 inside the ear canal 9. An external unit 10, well-known in the art, preferably contains both a microphone for picking up ambient sound as well as circuitry capable of receiving non-audio signals containing audio information, such as those using the Bluetooth or other RF protocol. The external unit converts what it receives into an electrical impulse 14 intended to drive a speaker. Wire 12 conducts the electrical impulse 14 to speaker 16, which is of conventional design. The speaker has an acoustic surface 17 at the medial end of the speaker 16 that interacts with the surrounding air to translate the electrical impulse 14 into sound 18. The sound 18 travels down sound tube 20, and strikes eardrum 22. Some of sound 18 also escapes from behind the speaker, that, due to a poor impedance match between the speaker 16, sound tube 20, and eardrum 22, tend to be partially reflected.

The prior art design is relatively easy to manufacture. A casting of the ear canal may be taken, and the earpiece 24 of the hearing aid 8 produced from this model with the tube 20 and speaker box 26 cast integrally. Typically, the lateral end 34 will be larger than the medial end 28, due to the nature of human ear canals and the need to avoid over-insertion. The speaker 16 may then be inserted into the speaker box 26 to complete assembly.

FIG. 2 shows a perspective view of one embodiment of a novel earpiece, while FIG. 4 shows the same earpiece in cross-section. In this embodiment, the speaker 16 is located in a speaker box 26 at the medial end 28 of the earpiece 24, as close as possible to the eardrum 22. A wire channel leading from the speaker box 26 to the lateral end 34 is connected to the speaker box 26 to provide a path for the wire 12. In a preferred embodiment, the wire channel takes the form of tube 30 and is as small as practical, as shown in FIG. 3. This design greatly reduces the escape of sound 18 from the back of the speaker, because it must travel through the narrow tube 30. For milder hearing losses a vent may be included in the conventional manner or may be made as a shallow groove 31 on the outside of the earpiece. The disclosed arrangement of speaker 16 and wire channel enhances clarity when compared to prior art because sound 18 is delivered directly to the eardrum 22 rather than forced through sound tube 20, so there are no resonance or impedance issues that degrade sound 18 before it can impinge on the eardrum 22. In addition, when the earmold 10 is removed from the ear canal 9 the speaker 16 cannot change position as the tube 30 is too narrow in lateral diameter to allow incursion of the speaker 16 into tube 30.

The disclosed hearing aid design does require a slightly more complicated manufacturing process. The creation of the earpiece 24 is performed in a conventional manner. A casting of a user's ear canal 9 is taken, and used to make a mold for the earpiece 24. The mold is then used to cast the earpiece 24 using materials and methods well known in the art. 3D scanning technology may be utilized in the casting process to make this process easier and safer. The speaker box 26 and wire channel may be cast integrally during the creation of the earpiece 24 or may be created with machining operations afterward. However, when the speaker is inserted into the speaker box 26, it is necessary to pass wire 12 through the tube 30. Most preferably, the tube 30 is only slightly larger than the wire 12, and the wire 12 is passed through with no connector 32 or other device attached, and a connection is made after the speaker 16 is in place. Both manufacturing and repair may be simplified if a sufficiently compact connector 32 is affixed to the wire 12. This requires a tube 30 sufficiently large to permit the connector 32 to pass through it. Although this will degrade performance somewhat by permitting more sound 18 to escape the ear, the disclosed design remains superior to the prior art, and some manufacturers may find the cost savings to be an acceptable compromise.

In cases of milder hearing loss, a vent is sometimes included in the earpiece to minimize the “stopped up” sensation that otherwise occurs. It is conventional to include a separate tube between the medial end 28 and the lateral end 34. However, groove 31 may also be extended all the way to the medial end 28. In such a case, the wire 12 should be passed through a wire tube 30 so that the groove 31 is not occluded.

Hearing aids according to the above teachings have been constructed and tested on users who are profoundly deaf. These users required prior art hearing aids to be operated at maximum power. The disclosed design results in improved speech comprehension and the ability to use lower volume settings, thus saving battery power.

The terms and expressions which have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims which follow.

1. An earpiece for a hearing aid capable of insertion into a user's ear canal, comprising:
a) a lateral end and a medial end;
b) a speaker box located closer to said medial end than said lateral end; and
c) a wire channel connected to said speaker box and passing from said speaker box to said lateral end.

2. The earpiece of claim 1, further comprising:
a) a wire located in said wire channel, said wire capable of carrying audio information to said speaker; and
b) a speaker located in said speaker box and connected to said wire, said speaker capable of reproducing in the form of sounds, the audio information transmitted through the wire.

3. The earpiece of claim 1, wherein said wire channel is an enclosed tube.

4. The earpiece of claim 1, further compromising a vent.

5. A method of manufacturing an earpiece for a hearing aid, comprising the steps of:
a) casting the earpiece with a medial end and a lateral end;
b) forming a speaker box closer to said medial end than said lateral end;
c) forming a wire channel passing from said speaker box to said lateral end;
d) inserting a wire into said wire channel;
e) connecting said wire to a speaker; and
f) inserting said speaker into said speaker box.

6. The method of claim 5 wherein said speaker is inserted into said speaker box from said medial end.
